(19) United States
(12) Patent Application Publication
(10) Pub. No.: US 2025/0358865 A1
(43) Pub. Date: Nov. 20, 2025

(54) TIMING ADVANCE MANAGEMENT TO REDUCE LATENCY

(71) Applicant: MEDIATEK INC., Hsinchu City (TW)

(72) Inventors: Din-Hwa Huang, Hsinchu City (TW); Cheng-Rung Tsai, Hsinchu City (TW)

(21) Appl. No.: 19/281,601

(22) Filed: Jul. 26, 2025

Related U.S. Application Data
(63) Continuation of application No. PCT/CN2024/076730, filed on Feb. 7, 2024.
(60) Provisional application No. 63/484,762, filed on Feb. 14, 2023.

(30) Foreign Application Priority Data
Feb. 7, 2024 (WO) PCT/CN2024/076730

(51) Int. Cl. H04W 74/0833; H04W 56/00; H04W 74/00; H04W 74/08

(52) U.S. Cl. CPC H04W 74/0833; H04W 56/0045; H04W 74/006; H04W 74/0891

(57) ABSTRACT

Apparatus and methods are provided for timing advance management for the UE in the LTM to reduce latency. In one novel aspect, early UL synchronization for timing advance management is provided. In one embodiment, the UE receives PDCCH order from the connected serving cell indicating an early UL synchronization procedure towards a candidate cell and receives a timing advance (TA) of the candidate cell in the cell switch command. In one embodiment, the PDCCH order indicates whether the PRACH is to be an initial transmission or a retransmission to the candidate cell and the UE increments a power ramping counter when the PDCCH order indicates a retransmission. In one embodiment, the PDCCH order includes a cell indicator of the candidate cell with one or more reserve bits of DCI 1_0 of the PDCCH order. In one embodiment, the PDCCH order indicates whether a RAR is expected.

### CROSS REFERENCE TO RELATED APPLICATIONS

This application is filed under 35 U.S.C. § 111(a) and is based on and hereby claims priority under 35 U.S.C. § 120 and § 365(c) from International Application No. PCT/CN2024/076730, with an international filing date of Feb. 7, 2024, which in turn claims priority from U.S. Provisional Application No. 63/484,762 entitled “Timing advance management to reduce latency,” filed on Feb. 14, 2023. This application is a continuation of International Application No. PCT/CN2024/076730, with an international filing date of Feb. 7, 2024, which in turn claims priority from U.S. Provisional Application No. 63/484,762 entitled “Timing advance management to reduce latency,” filed on Feb. 14, 2023. International Application No. PCT/CN2024/076730 is pending as of the filing date of this application, and the United States is a designated state in International Application No. PCT/CN2024/076730. The disclosure of each of the foregoing documents is incorporated herein by reference.

### TECHNICAL FIELD

The disclosed embodiments relate generally to wireless communication, and, more particularly, to timing advance management to reduce latency.

### BACKGROUND

Mobility performance is a very important metric in a wireless communication system. Researchers are working hard on reducing handover delay and interruption. The shorter the delay and interruption are, the less data would be lost. To reduce handover delay, L1/L2 triggered mobility is designed to enable a serving cell change via L1/L2 signaling, while keeping configuration of the upper layers and/or minimizing changes of configuration of the lower layers. This helps to reduce the latency, overhead and interruption time during handover. The LTM supports both intra-distributed unit (DU) and intra-central unit (CU)-inter-DU mobility. During the LTM, user plane is continued whenever possible (e.g. intra-DU), without reset, with the target cell to avoid data loss and the additional delay of data recovery. However, traditional LTM still suffers from relatively long interruptions due to downlink (DL) and uplink (UL) synchronization, random access (RA) procedures etc.

Improvements and enhancements are required to reduce interruption for LTM.

### SUMMARY

Apparatus and methods are provided for timing advance management for the UE in the LTM to reduce latency. In one novel aspect, early UL synchronization for timing advance management is provided. In one embodiment, the UE receives PDCCH order from the connected serving cell, wherein the PDCCH order indicates an early uplink (UL) synchronization procedure towards a candidate cell, transmits a physical random access channel (PRACH) preamble to the candidate cell for the UL synchronization procedure based on the PDCCH order, and receives a timing advance (TA) of the candidate cell in the cell switch command. In one embodiment, the PDCCH order indicates whether the PRACH is to be an initial transmission or a retransmission to the candidate cell. In another embodiment, the UE increments a power ramping counter when the received PDCCH order indicates a retransmission and indicates the same associated SSB and same candidate cell with the last PDCCH order for RACH. In one embodiment, the PDCCH order includes at least one cell indicator of the candidate cell with one or more reserve bits of DCI 1_0 of the PDCCH order. In another embodiment, the cell indicator is an index indicating identifier of the candidate cell. In one embodiment, the PDCCH order indicates whether a random access response (RAR) is expected by providing a cell indicator in the PDCCH order. In another embodiment, the UE receives from the serving cell a RAR for the candidate cell to obtain the candidate cell TA when the RAR is indicated. In one embodiment, the UE obtains the candidate cell TA based on the cell switch command received on the serving cell when the RAR is not indicated. In another embodiment, UE capability information relating to TA/TAG acquisition by early UL synchronization procedure before a cell switch command is indicated to the wireless network. In one embodiment, the UE further receives RACH resource configuration from the wireless network before the PDCCH order, and receives a MAC CE for the cell switch command.

This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1A is a schematic system diagram illustrating an exemplary wireless network with timing advancing management to reduce latency in accordance with embodiments of the current invention.

FIG. 1B illustrates an exemplary UE and base station with timing advancing management to reduce latency in accordance with embodiments of the current invention.

FIG. 2 illustrates exemplary diagrams for the UE to perform timing advance management for LTM in accordance with embodiments of the current invention.

FIG. 3 illustrates exemplary diagrams for timing advance management for the UE performing early UL synchronization with different RAR scenarios in accordance with embodiments of the current invention.

FIG. 4 illustrates exemplary diagrams for the UE to perform power ramping and increase power ramping counter upon detecting the PRACH being a retransmission in accordance with embodiments of the current invention.

FIG. 5 illustrates an exemplary flow chart for the UE timing advance management for LTM to reduce latency in accordance with embodiments of the current invention.

### DETAILED DESCRIPTION

Reference will now be made in detail to some embodiments of the invention, examples of which are illustrated in the accompanying drawings.

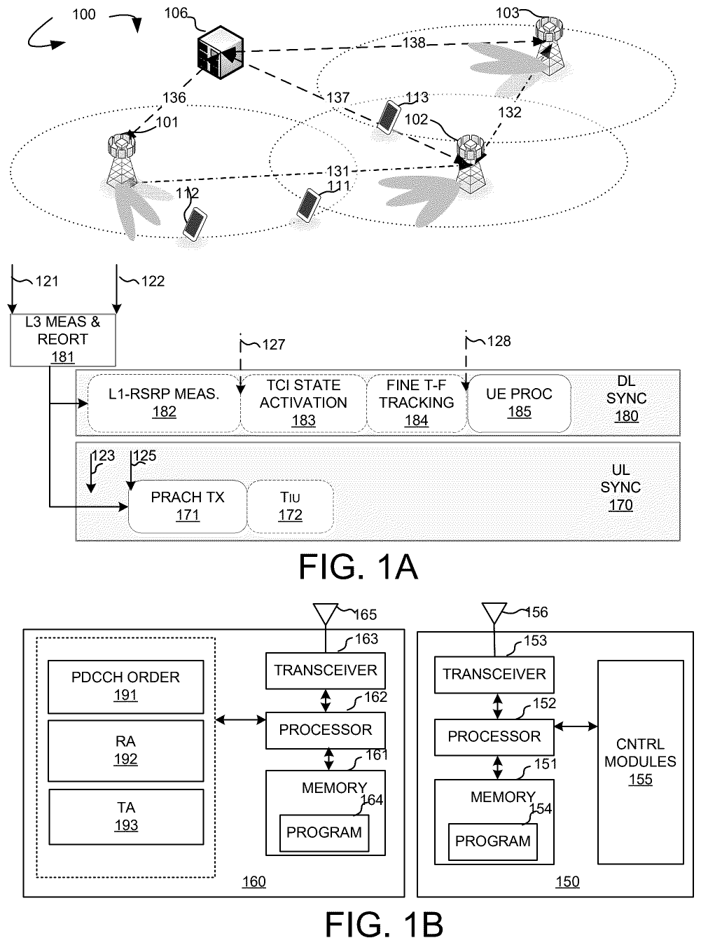

FIG. 1A is a schematic system diagram illustrating an exemplary wireless network with timing advancing management to reduce latency in accordance with embodiments of the current invention. Wireless system 100 includes one or more fixed base infrastructure units forming a network distributed over a geographical region. As an example, base stations/gNBs 101, 102, and 103 serve a number of mobile stations, such as UE 111, 112, and 113, within a serving area, for example, a cell, or within a cell sector. In some systems, one or more base stations are coupled to a controller forming an access network that is coupled to one or more core networks, through a network entity, such as network entity 106. gNB 101, gNB 102 and gNB 103 are base stations in NR, the serving area of which may or may not overlap with each other. As an example, UE or mobile station 112 is only in the service area of gNB 101 and connected with gNB 101. UE 112 is connected with gNB 101 only. UE 111 is in the overlapping service area of gNB 101 and gNB 102 and may switch back and forth between gNB 101 and gNB 102. UE 113 in the overlapping service area of gNB 102 and gNB 103 and may switch back and forth between gNB 102 and gNB 103. Base stations, such as gNB 101, 102, and 103 are connected the network through network entities, such as network entity 106 through NG connections, such as 136, 137, and 138, respectively. Xn connections 131 and 132 connect the non-co-located receiving base units. Xn connection 131 connects gNB 101 and gNB 102. Xn connection 132 connects gNB 102 and gNB 103. These Xn/NG connections can be either ideal or non-ideal.

In one novel aspect, timing advance management is performed by the UE to reduce handover latency. For a legacy handover, a handover command is received by the UE for cell switch before DL and UL synchronization. The interruption for legacy handover starts when the traditional handover command is received and the UE performs DL synchronization, UL synchronization, reconfiguration and processing for new TCI state. With the development of LTM, the UE receives pre-configuration for LTM before the cell switch command is received. The UE performs DL synchronization before receiving the cell switch command. The processing time for DL synchronization is saved. Interruption for the first case of LTM is reduced. In one novel aspect, the early UL synchronization 170 is performed before the cell switch command. The interruption 178 for the second case is further reduced. FIG. 1A further illustrates an exemplary flow diagram. At step 121, the UE receives RRC measurement configuration. At 181, L3 measurement and reporting is performed. Procedures 181 may include cell search, cell measurement and SSB time index acquisition, and L3 reporting. At step 122, the UE receives early synchronization configuration. DL synchronization 180 and UL synchronization 170 is performed before the cell switch command is received. As an example, DL synchronization 180 includes L1 RSRP measurement 182. In one embodiment, based on the L1 RSRP, at step 127, the network sends MAC CE to activate one or more TCI states. At step 183, the UE performs TCI state activation based on the MAC CE. At step 184, the UE performs fine T-F tracking. At step 128, the UE receives cell switch command. In one embodiment, the cell switch command is included in the MAC CE. In another embodiment, the TCI state activation and the cell switch command are included in one MAC CE. At step 185, the UE processes the cell switch command and switch to the target cell. In one novel aspect, the UL synchronization 170 is performed before the cell switch command. At step 123, the UE receives RRC RACH resource configuration. At step 125, the UE receives the PDCCH order. At step 171, the UE transmits the PRACH. A T_{IU} 172 is incurred for the UL synchronization.

FIG. 1B illustrates an exemplary UE and base station with timing advancing management to reduce latency in accordance with embodiments of the current invention. Diagram 160 is an exemplary simplified block diagram of a base station/gNB. The base station has antenna 156, which transmits and receives radio signals. An RF transceiver circuit 153, coupled with the antenna, receives RF signals from antenna 156, converts them to baseband signals, and sends them to processor 152. RF transceiver 153 also converts received baseband signals from processor 152, converts them to RF signals, and sends out to antenna 156. Processor 152 processes the received baseband signals and invokes different functional modules to perform features in the base station. Memory 151 stores program instructions and data 154 to control the operations of the base station. The base station also includes a set of control modules 155 that carry out functional tasks to communicate with mobile stations.

Diagram 160 illustrates simplified block diagrams of a mobile device/UE for enhanced cell change procedure. The UE has antenna 165, which transmits and receives radio signals. An RF transceiver circuit 163, coupled with the antenna, receives RF signals from antenna 165, converts them to baseband signals, and sends them to processor 162. In one embodiment, the RF transceiver may comprise two RF modules (not shown) for different frequency bands transmitting and receiving. RF transceiver 163 also converts received baseband signals from processor 162, converts them to RF signals, and sends out to antenna 165. Processor 162 processes the received baseband signals and invokes different functional modules to perform features in the UE. Memory 161 stores program instructions and data 164 to control the operations of the UE. Antenna 165 sends uplink transmissions and receives downlink transmissions to/from the base station.

The UE also includes a set of control modules that carry out functional tasks. These control modules can be implemented by circuits, software, firmware, or a combination of them. A PDCCH order module 191 receives a PDCCH order in a UE connected state from a source cell in the wireless network, wherein the PDCCH order indicates an early uplink (UL) synchronization procedure towards a candidate cell and indicates whether the PRACH preamble transmission is to be an initial transmission or a retransmission to the candidate cell, and wherein the early UL synchronization procedure is performed before a cell switch command. A random access (RA) module 192 transmits a physical random access channel (PRACH) preamble to the candidate cell for the UL synchronization procedure based on the PDCCH order. A timing advance (TA) module 193 receives a TA of the candidate cell in the cell switch command.

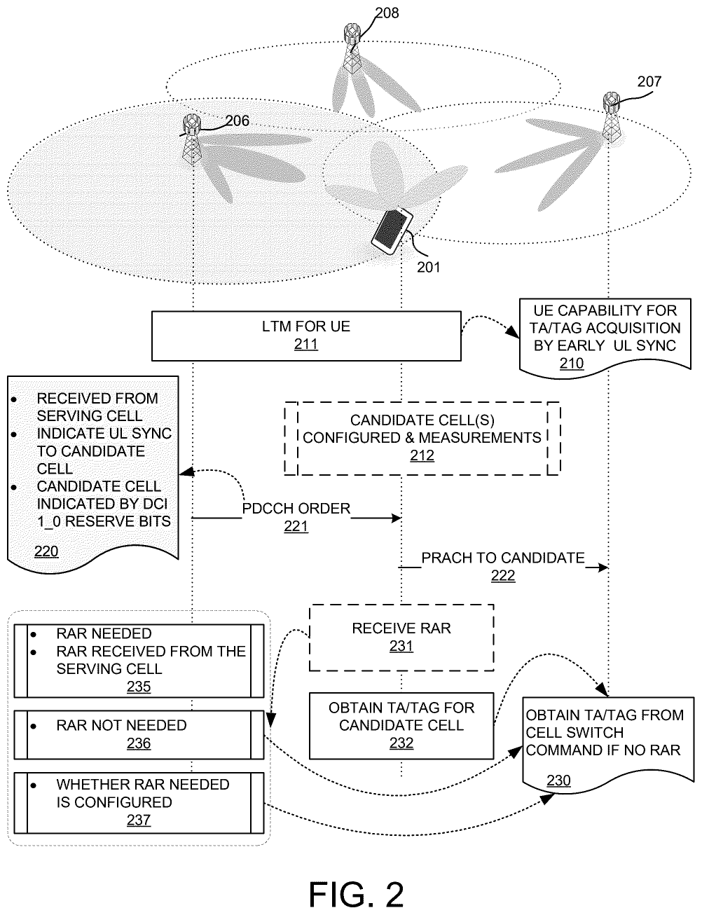

FIG. 2 illustrates exemplary diagrams for the UE to perform timing advance management for LTM in accordance with embodiments of the current invention. In one novel aspect, the UE obtains TA for candidate cell before the cell switch procedures to reduce the handover interruption. UE 201 is connected with source cell gNB 206. At step 211, the LTM is initiated for UE 201 with neighboring/candidate cells served by gNB 207 and 208. In one embodiment, the UE is configured to support early UL synchronization. In one embodiment 210, UE capability information relating to TA/TAG acquisition by early UL synchronization procedure is indicated to the wireless network. In one embodiment, the UE capability information indicates an early UL synchronization procedure is supported. In another embodiment, the UE capability information indicates one TA/TAG per candidate cell can be acquired. In yet another embodiment the number of TAs/TAGs among all candidate cells can be larger than one. In another embodiment, the maximum number of TAs/TAGs is indicated. At step 212, the UE receives one or more candidate cells information. The UE performs measurements for the one or more candidate cells.

In one novel aspect, the UE receives PDCCH order from the serving cell indicating a UL synchronization procedure towards a candidate cell. At step 221, UE 201 receives PDCCH order from serving/source cell 206. In embodiments 220, the PDCCH order is received from the serving cell. The PDCCH order indicates UL synchronization procedure for the UE towards at least one candidate cell, such as candidate cell 207 or 208. In one embodiment, the candidate cell information in PDCCH order is indicated by reserve bits of the DCI 1_0. At step 222, UE 201 transmits PRACH/PRACH preamble to candidate cell 207. Optionally, at step 231, UE 201 receives RAR. In one embodiment 235, the RAR is needed for the early UL synchronization procedure. In one embodiment, when the RAR is needed, UE 201 receives RAR from serving cell 206. In another embodiment 236, RAR is not needed. In another embodiment 237, whether the RAR is needed is configured. In one embodiment, the indication of whether RAR is needed/expected is included in the PDCCH order. At step 232, UE 201 obtains TA/TAG for candidate cell 207. In one embodiment 230, when RAR is not needed/configured, the UE obtains the TA/TAGs information for candidate cell 207 from the cell switch command received from the serving cell 206. In another embodiment, when the RAR is needed/configured, the UE obtains the TA/TAG information of candidate cell 207 based on the RAR received from the serving cell 206.

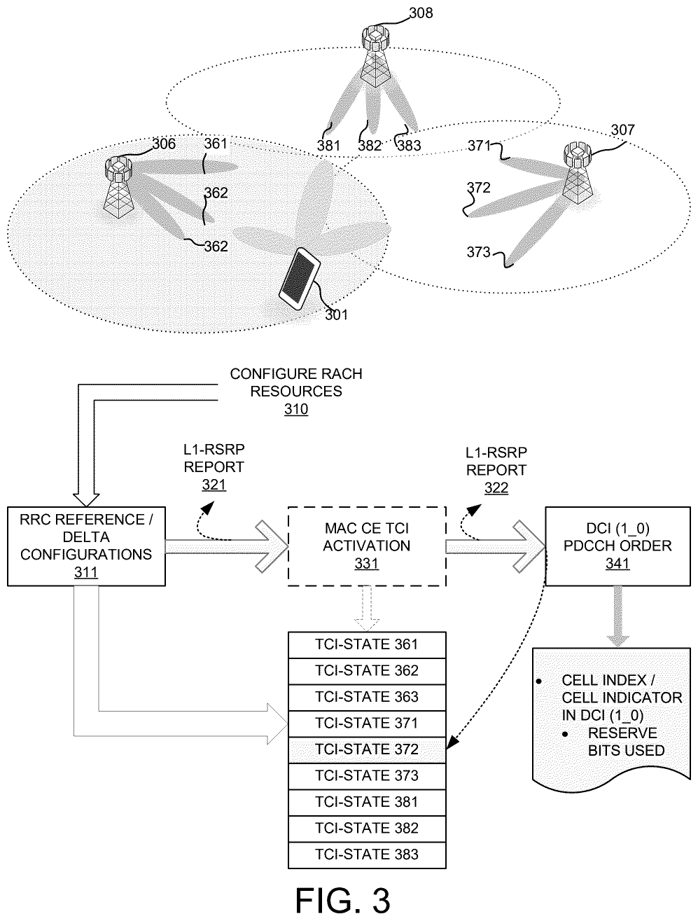

FIG. 3 illustrates exemplary diagrams for timing advance management for the UE performing early UL synchronization with different RAR scenarios in accordance with embodiments of the current invention. In one novel aspect, the UE obtains TA/TAG information for the candidate/target cell with early UL synchronization for the LTM procedure. UE 301 is connected with the serving cell through gNB 306. At step 310, UE 301 receives information through serving cell gNB 306 configured RACH resources. In one embodiment 311, the RACH resource configuration for candidate cell/beam is received through RRC reference or delta configurations. At step 321, UE 301 performs layer-1 (L1) reference signal received power (RSRP) measurement and sends L1 RSRP report to the wireless network. As an example, UE L1 measurements include TCI state 361, TCI state 362, and TCI state 363 for serving cell served by gNB 306. UE L1 measurement report also include neighboring cell report, such as neighboring cell served by gNB 307, and neighboring cell served by gNB 308. Neighboring cell L1 measurement report includes TCI state 371, TCI state 372, and TCI state 373 for neighboring cell served by gNB 307 and TCI state 381, TCI state 382, and TCI state 383 for neighboring cell served by gNB 308. In one embodiment, at step 331, UE 301 receives TCI state activation through MAC CE from the wireless network. At step 322, the UE performs L1 RSRP measurement based on the MAC CE and sends L1 measurement report to the wireless network. At step 341, the UE receives PDCCH order by DCI 1_0 through the serving cell by gNB 306. In one embodiment, one indication is introduced in the PDCCH order to inform UE 301 whether RAR is needed. In one embodiment, if RAR is indicated, UE 301 expects that RAR will be received from the serving cell 306. If reception of RAR is not configured/indicated, UE 301 expects no MSG2 will be transmitted by the network. UE 301 obtains TA value of target cell in the cell switch command. In one embodiment, the cell index or cell indicator is included in the PDCCH order. In one embodiment, the reserved bit(s) of the DCI 1_0 are used to indicate the candidate cell or the TCI state of the candidate cell for the UE to transmit the PRACH.

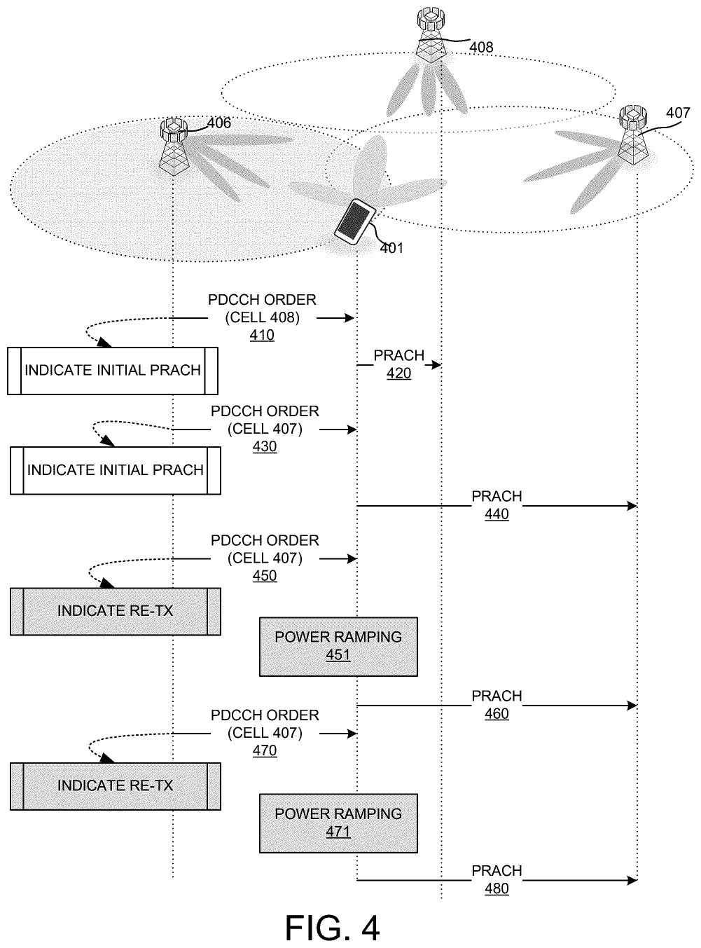

FIG. 4 illustrates exemplary diagrams for the UE to perform power ramping and increase power ramping counter upon detecting the PRACH being a retransmission in accordance with embodiments of the current invention. In one embodiment, the PDCCH order indicates whether the PRACH is to be an initial transmission or a retransmission to the candidate cell. In one embodiment, the UE increments a power ramping counter when the PDCCH order indicates a retransmission. In one embodiment, the power ramping counter is increased by one. UE 401 is connected with the serving cell served by gNB 406. UE 401 also has exemplary candidate/neighboring cells served by gNB 407 and gNB 408. At step 410, UE 401 receives PDCCH order indicating PRACH towards neighboring cell served by gNB 408. In one embodiment, the PDCCH order also indicates whether the PRACH by the UE to the indicated candidate cell is an initial transmission or a retransmission. At step 410, the PDCCH order indicates an initial transmission. UE 401, at step 420, transmits PRACH towards UE 408 without power ramping. Subsequently, at step 430, UE 401 receives another PDCCH order from serving cell served by gNB 406 indicating PRACH towards neighboring cell served by gNB 407. At step 430, the PDCCH order indicates an initial transmission. The PDCCH order indicates it is an initial transmission when the indicated candidate cell is a new candidate cell. At step 440, UE 401 transmits PRACH towards UE 408 without power ramping.

Subsequently, at step 450, UE 401 receives another PDCCH order from serving cell served by gNB 406 indicating PRACH towards neighboring cell served by gNB 407. At step 450, the PDCCH order indicates a retransmission. In one embodiment, when the UE receives the PDCCH order indicating a retransmission, the UE performs power ramping and increases the power ramping counter. At step 451, UE 401 increases the power and increases the power ramping counter. In one embodiment, the power ramping counter is increased by one. At step 460, UE 401 transmits the PRACH with power ramped to the neighboring cell served by gNB 407. Subsequently, at step 470, UE 401 receives another PDCCH order from serving cell served by gNB 406 indicating PRACH towards neighboring cell served by gNB 407. At step 470, the PDCCH order indicates a retransmission. At step 471, UE 401 increases the power and increases the power ramping counter. In one embodiment, the power ramping counter is increased by one. At step 480, UE 401 transmits the PRACH with power ramped to the neighboring cell served by gNB 407.

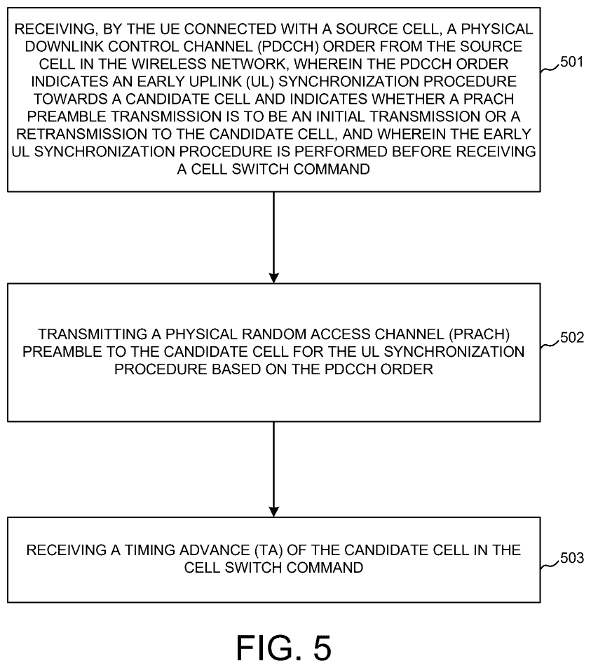

FIG. 5 illustrates an exemplary flow chart for the UE timing advance management for LTM to reduce latency in accordance with embodiments of the current invention. At step 501, the UE connected with the source cell receives a PDCCH order from a source cell in the wireless network, wherein the PDCCH order indicates an early uplink (UL) synchronization procedure towards a candidate cell and indicates whether the PRACH preamble transmission is to be an initial transmission or a retransmission to the candidate cell, wherein the early UL synchronization procedure is performed before receiving the cell switch command. At step 502, the UE transmits a physical random access channel (PRACH) preamble to the candidate cell for the UL synchronization procedure based on the PDCCH order. At step 503, the UE receives a timing advance (TA) of the candidate cell in the cell switch command.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method for a user equipment (UE) in a wireless network, comprising:
receiving, by the UE connected with a source cell, a physical downlink control channel (PDCCH) order from the source cell in the wireless network, wherein the PDCCH order indicates an early uplink (UL) synchronization procedure towards a candidate cell and indicates whether a PRACH preamble transmission is to be an initial transmission or a retransmission to the candidate cell, and wherein the early UL synchronization procedure is performed before receiving a cell switch command;
transmitting a physical random access channel (PRACH) preamble to the candidate cell for the UL synchronization procedure based on the PDCCH order; and
receiving a timing advance (TA) of the candidate cell in the cell switch command.

2. The method of claim 1, wherein the UE increments a power ramping counter when the received PDCCH order indicates a retransmission and the received PDCCH order indicates the same associated SSB and same candidate cell with the last PDCCH order for RACH.

3. The method of claim 1, wherein the PDCCH order includes at least one cell indicator of the candidate cell with one or more reserved bits of DCI 1_0 of the PDCCH order.

4. The method of claim 3, wherein the cell indicator is an index indicating an identifier of the candidate cell.

5. The method of claim 1, wherein the PDCCH order indicates whether a random access response (RAR) is expected by providing a cell indicator in the PDCCH order.

6. The method of claim 5, wherein the UE receives from the serving cell a RAR for the candidate cell to obtain the candidate cell TA when the RAR is indicated.

7. The method of claim 5, wherein the UE obtains the candidate cell TA based on the cell switch command received on the serving cell when the RAR is not indicated.

8. The method of claim 1, wherein UE capability information relating to TA/TAG acquisition by early UL synchronization procedure is indicated to the wireless network.

9. The method of claim 1, further comprising:
receiving RACH resource configuration from the wireless network before the PDCCH order; and
receiving a MAC CE for the cell switch command.

10. A user equipment (UE), comprising:
a transceiver that transmits and receives radio frequency (RF) signal in a wireless network;
a physical downlink control channel (PDCCH) order module that receives a PDCCH order in a UE connected state from a source cell in the wireless network, wherein the PDCCH order indicates an early uplink (UL) synchronization procedure towards a candidate cell and indicates whether a PRACH preamble transmission is to be an initial transmission or a retransmission to the candidate cell, and wherein the early UL synchronization procedure is performed before receiving a cell switch command;
a random access (RA) module that transmits a physical random access channel (PRACH) preamble to the candidate cell for the UL synchronization procedure based on the PDCCH order; and
a timing advance (TA) module that receives a TA of the candidate cell in the cell switch command.

11. The UE of claim 10, wherein the UE increments a power ramping counter when the received PDCCH order indicates a retransmission and the received PDCCH order indicates the same associated SSB and same candidate cell with the last PDCCH order for RACH.

12. The UE of claim 10, wherein the PDCCH order includes at least one cell indicator of the candidate cell with one or more reserved bits of DCI 1_0 of the PDCCH order.

13. The UE of claim 12, wherein the cell indicator is an index indicating an identifier of the candidate cell.

14. The UE of claim 10, wherein the PDCCH order indicates whether a random access response (RAR) is expected by providing a cell indicator in the PDCCH order.

15. The UE of claim 14, wherein the UE receives from the serving cell a RAR for the candidate cell to obtain the candidate cell TA when the RAR is indicated.

16. The UE of claim 14, wherein the UE obtains the candidate cell TA/TAG based on a cell switch command received on the serving cell when the RAA is not indicated.

17. The UE of claim 10, wherein UE capability information relating to TA/TAG acquisition by early UL synchronization procedure is indicated to the wireless network.

18. The UE of claim 10, wherein the RA module further receives RACH resource configuration from the wireless network before the PDCCH order; and receives a MAC CE for the cell switch command.
